(19) United States
(12) Patent Application Publication
(10) Pub. No.: US 2006/0278716 A1
(43) Pub. Date: Dec. 14, 2006

(54) INPUT DEVICE AND INPUT SYSTEM

(75) Inventors: Masashi FUJITA, Tokyo (JP); Yoshiyuki KUROKAWA, Kanagawa (JP)

Correspondence Address: FISH & RICHARDSON P.C., P.O. BOX 1022, MINNEAPOLIS, MN, 55440-1022, US

(73) Assignee: SEMICONDUCTOR ENERGY LABORATORY CO., LTD., Atsugi-shi (JP)

(21) Appl. No.: 11/420,912

(22) Filed: May 30, 2006

(30) Foreign Application Priority Data
May 31, 2005 (JP) 2005-160751

(51) Int. Cl. G06K 7/10

(52) U.S. Cl. 235/472.02

(57) ABSTRACT

To provide a foot-operated input system having a function of cursor operation, substituting a mouse, by which operation can be conducted without causing strain on the foot and body by using a radio signal, and operation efficiency of an electric device such as a computer can be improved. Using a foot-operated input system, cursor operation with foot is realized as follows. An input system using a radio signal is provided under a desk on which an electric device such as a computer is disposed. The operator wears a footwear fitted with a reader/writer, and puts the foot on wireless chips. The reader/writer receives positional information from the wireless chips through communication between the reader/writer and the wireless chips. The positional information is reflected in the position of a cursor.

### BACKGROUND OF THE INVENTION

1. Field of the Invention

The present invention relates to an input system of an input device which inputs a signal into an electric device such as a computer, a game machine or the like.

2. Description of the Related Art

In recent years, as the technology of computers has advanced, there are many opportunities to operate computers in business and life. Generally, computers are provided with input devices operated by hand. The input devices mainly include mice having functions of operating cursors and selecting text or files, and keyboards having a function of inputting text.

FIG. 11 shows a configuration of a computer 21 and an input device thereof. A desk 24 is prepared and a display 20 is disposed over a desk 24. A keyboard 23 is disposed in front of the display 20, and a mouse 22 is placed next to the keyboard 23. Generally, the mouse 22 is operated with the dominant hand, so it is placed on the dominant hand side of an operator. The computer 21 is placed freely on the space above or below the desk 24.

In a configuration in FIG. 11, an operator often operates the mouse 22 and the keyboard 23 alternately or simultaneously. In that case, the operator operates the keyboard 23 with one hand and operates the mouse 22 with the other hand; alternatively, the operator operates keyboard 23 with both hands releasing the mouse 22. Normally, the operation can be performed more rapidly when the keyboard 23 is operated with both hands compared with the case of operation with one hand. Consequently, one hand is frequently moved between the keyboard 23 and the mouse 22 and the operational efficiency is reduced accordingly.

As a measure to solve the problem, a foot-operated mouse is invented (for example, Reference 1: Japanese Patent Laid-Open No. 2000-181621).

### SUMMARY OF THE INVENTION

An operator of a computer generally operates a mouse and a keyboard alternately or simultaneously. Conventionally, a keyboard is operated with one hand, and a mouse is operated with the other hand; alternatively, the keyboard is operated with both hands leaving the mouse. Normally, the operation can be performed more rapidly when the keyboard is operated with both hands compared with the case of operation with one hand. Consequently, one hand is frequently moved between the keyboard and the mouse and the operational efficiency is reduced accordingly.

As a measure to solve the problem, a foot-operated mouse is invented as disclosed in Reference 1. However, a mouse ball is used in this mouse for cursor operation, which causes strain on the foot and body, and it is not suited for continuous operations for a long time. Further, when a mouse ball is used, the operability of the mouse is dependent on the material of the floor.

In view of the above problems, it is an object of the present invention to provide a foot-operated input system and a input method using a radio signal in place of a mouse, which can improve efficiency in operating a computer and can be comfortably operated independently of the material of the floor without causing strain on the foot and the body.

In order to solve the problems, in the present invention, an input system using a radio signal is provided under a desk on which an electric device such as a computer, a game machine or the like is disposed and it is operated with a foot of the operator of the electric device, thereby achieving cursor operation similar to operation using a pointing device operated with a hand.

Specific structures of the invention will be described below.

One mode of the invention is an input device for inputting a signal into an electric device, including a sheet on which a wireless chip capable of reading positional information by wireless communication containing the positional information are arranged and a pointing device capable of wirelessly communicating with the wireless chip, which is movably disposed over the sheet.

Another mode of the invention is an input device for inputting a signal into an electric device, including a sheet on which a wireless chip capable of reading positional information by wireless communication containing the positional information are arranged and a pointing device capable of wirelessly communicating with the wireless chip, which is movably disposed over the sheet, wherein the wireless chip each have a resonant circuit, a power circuit connected to the resonant circuit, and a memory circuit connected to the power circuit.

Another mode of the invention is an input system including an electric device displaying a cursor and an input device which inputs a signal into the electric device, wherein the input device includes a sheet on which a wireless chip capable of reading positional information by wireless communication containing the positional information are arranged and a pointing device capable of wirelessly communicating with the wireless chip, which is movably disposed over the sheet.

Another mode of the invention is an input system including an electric device displaying a cursor and an input device which inputs a signal into the electric device,

wherein the input device includes a sheet on which a wireless chip capable of reading positional information by wireless communication containing the positional information are arranged and a pointing device capable of wirelessly communicating with the wireless chip, which is movably disposed over the sheet, and the wireless chip each have a resonant circuit, a power circuit connected to the resonant circuit, and a memory circuit connected to the power circuit.

Another mode of the invention is an input device for inputting a signal into an electric device, comprising a sheet on which a plurality of wireless chips capable of reading positional information by wireless communication containing the positional information are arranged and a pointing device capable of wirelessly communicating with the wireless chips, which is movably disposed over the sheet, wherein the pointing device includes an analyzing portion of positional information for obtaining information of a position on the sheet by reading information in the plurality of wireless chips provided adjacent to each other and a sending portion of the positional information to the electric device.

Another mode of the invention is an input device for inputting a signal into an electric device, including a sheet on which a plurality of wireless chips capable of reading positional information by wireless communication containing the positional information are arranged and a pointing device capable of wirelessly communicating with the wireless chips, which is movably disposed over the sheet, wherein the wireless chips each have a resonant circuit, a power circuit connected to the resonant circuit, and a memory circuit connected to the power circuit and the pointing device includes an analyzing portion of positional information for obtaining information of a position on the sheet by reading information in the plurality of wireless chips provided adjacent to each other and a sending portion of the positional information to the electric device.

Note that the wireless chips can be formed using thin film transistors (TFT).

In the present invention, when cursor operation is performed with a foot, a position is detected using a radio signal, so that the weight of the input system is made lighter than the case of using a mouse ball and strain on the foot and body can be lightened accordingly; thus, continuous operation for a long time can be performed. Further, it can be comfortably operated independently of the material of the floor.

Thus, cursor operation can be performed with a foot and a keyboard can be operated with both hands, redundant operations can be reduced, and efficiency in operating an electric device can be improved. In addition, space left empty on a desk can be used for another purpose.

Further, since wireless chips using thin film transistors (TFT) are used, the wireless chips can be formed directly on a sheet without a step of embedding the wireless chips into a sheet formed of an insulator; thus, the process can be simplified.

### BRIEF DESCRIPTION OF DRAWINGS

In the accompanying drawings:

FIGS. 1A to 1D are perspective views showing a configuration of a first mode in the present invention;

FIGS. 2A to 2D are perspective views showing a configuration of a second mode in, the present invention;

FIGS. 3A to 3C are perspective views showing a configuration of the present invention;

FIGS. 4A to 4C are block diagrams showing a configuration of the present invention;

FIGS. 5A to 5C are block diagrams showing a configuration of the present invention;

FIG. 6 is a cross-sectional view showing a structure of a wireless chip of the present invention;

FIGS. 7A to 7E are top views showing structures of wireless chips of the present invention;

FIGS. 8A and 8B are top views of a memory circuit of a wireless chip in the present invention;

FIGS. 9A and 9B are top views of a memory circuit of a wireless chip in the present invention;

FIGS. 10A and 10B are top views of a memory circuit of a wireless chip in the present invention; and

FIG. 11 is a perspective view showing a structure of a conventional computer.

### DETAILED DESCRIPTION OF THE INVENTION

Embodiment Modes and Embodiments of the present invention will be described with reference to the drawings. Note that the present invention can be embodied with many different modes, and it is easily understood by those skilled in the art that the mode and detail can be variously modified without departing from the sprit and scope of the present invention. Therefore, the present invention is not construed as being limited to the description of Embodiment Modes and Embodiments. In all the drawings for describing Embodiment Modes and Embodiments, the same reference numerals are given to parts having similar functions or the same functions, and the description of such parts will not be repeated.

### Embodiment Mode 1

This embodiment mode will explain a mode in which cursor operation similar to operation using a pointing device, especially a mouse, which is operated with a hand can be achieved by providing an input system using a radio signal under a desk on which a computer is disposed and by operating the input system with foot of the operator of the computer.

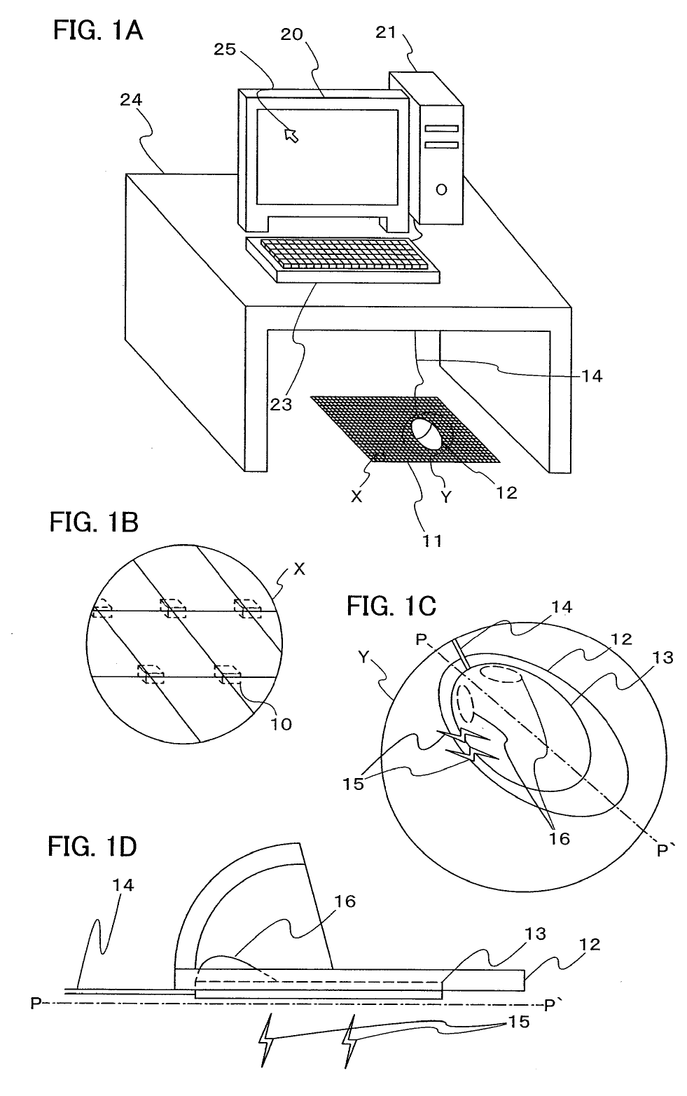

FIG. 1A shows a structure with which an input system using a radio signal 15 is provided under a desk 24 on which a computer 21 is disposed, and an operator of the computer 21 moves his/her foot wearing a footwear 12 equipped with a reader/writer 13, thereby achieving operation of a cursor 25 similarly to the case of operating a mouse 22 with a hand. Note that a cursor is also referred to as a mouse cursor or a mouse pointer, and the cursor 25 is displayed on a display 20 of the computer 21. Typically, the mouse 22 is moved using a symbol having a shape of an arrow, and the cursor 25 correspondingly moves on the display 20. The shape and the function of the mouse are changed in accordance with the state or the location, and an operation which can be performed changes. This explanatory drawing shows the case where a right foot wears the footwear 12; however, it is not limited thereto, and a left foot may wear the foot wear.

In FIG. 1A, wireless chips (or wireless tags) 10 manufactured by forming a semiconductor integrated circuit or antenna over a substrate of a single crystal such as silicon, a glass substrate, or a plastic substrate and a reader/writer 13 which transmits and receives the radio signal to/from the wireless chips 10 are used for the input system using the radio signal 15.

In the case of using a glass substrate, a surface opposite to the side where a semiconductor integrated circuit is formed can be polished, so that the substrate is made thinner Accordingly, flexibility of semiconductor integrated circuit formed over a glass substrate can be increased.

Note that a plastic substrate refers to a substrate having flexibility, and a plastic includes, for example, polynorbornene, polyethylene terephthalate (PET), polyethersulfone (PES), polyethylene naphthalate (PEN), polycarbonate (PC), nylon, polyetheretherketone (PEEK), polysulfone (PSF), polyetherimide (PEI), polyarylate (PAR), polybutylene terephthalate (PBT), polyimide, or the like which has a polar group.

In view of the above problems, a plurality of wireless chips 10 storing positional information are prepared, the wireless chips 10 are embedded in a sheet 11 manufactured with an insulator in accordance with the positional information in the wireless chips 10 as shown in FIG. 1B. FIG. 1B is an enlarged view of X in FIG. 1A. This sheet 11 is laid on a floor with the surface provided with the wireless chips face up under the desk 24 on which the computer 21 is disposed. For example, the sheet 11 is preferably disposed so that a predetermined lateral direction of the sheet 11 is parallel to a longitudinal direction of a screen of the display 20. Note that it is not preferable that the left and the right of the sheet 11 is reversed. Note that the size and the manner of disposition of the sheet 11 are not limited in particular. Further, the sheet 11 may be attached to the floor with a seal or an adhesive tape.

Since a plurality of wireless chips 10 are used here, the reader/writer 13 may simultaneously receive a plurality of radio signals 15. In the case where the signals are simultaneously received, radio signals 15 impinge on each other, and correct information cannot be extracted from the radio signals 15. Therefore, as a method for preventing the malfunction, when the wireless chips 10 are provided on the sheet 11 with some distances therebetween. The radio signals 15 severally outputted from the wireless chips 10 and the reader/writer 13 are not required to be sent far, so that the output can be reduced to the minimum.

Distances between vertices of a lattice is determined as appropriate. Note that since a system of the present invention is operated with a foot, detailed operation is difficult compared with the case of manual operation, and the operation is rougher. Accordingly, operation result is reduced and reflected in the cursor operation.

Note that the present invention does not necessarily require a plurality of wireless chips. For example, when one wireless chip and a plurality of (for example two) reader/writers are prepared, movements and positions of the plurality of reader/writers can be seen. For example, one wireless chip is prepared in a certain space, and the two reader/writers provided on a footwear or the like are approximated to the space. When the distance between the reader/writers and the wireless chip or the speed of the reader/writers change, the phase or the amplitude changes accordingly. Two distances between the reader/writers and the wireless chip can be calculated from the changes, and the position can be determined. Naturally, a plurality of wireless chips can be used when the system is used.

Further, similarly, one wireless chip and a plurality of (for example, two) reader/writers are prepared, and the position or the movement of the wireless chip can be seen on the contrary. For example, two spaced reader/writers are prepared as a position sensor on the edge of a certain space, and the wireless chip provided on a footwear or the like is approximated to the space. When the wireless chip is approximated to the reader/writers, the phase or the amplitude changes. Two distances between the reader/writers and the wireless chip can be calculated from the changes, and the position can be determined. Naturally, a plurality of wireless chips can be used when the system is used.

Meanwhile, as shown in FIG. 1C, the wireless chips 10 and the reader/writer 13 which transmits and receives the radio signal 15 is attached on the undersurface of the footwear 12. FIG. 1C is a figure showing Y in FIG. 1A, and is a figure showing the undersurface of the footwear 12. Here, in order to reliably receive the radio signal 15, an antenna is preferably disposed on the undersurface of the footwear 12, so that the radio signal 15 can be received without any obstruction. Further, the footwear 12 footwear may have a structure in which only an antenna portion of the reader/writer 13 is attached, the other parts of the reader/writer 13 except the antenna is provided outside the footwear 12, and they are connected through a cable 14. With this structure, the weight of the footwear 12 which is actually operated can be reduced and strain on the foot and body can be lightened, which is preferable.

In addition, in order to improve operational efficiency, at least one or more switches 16 for selecting the mouse 22 are provided on the reader/writer 13. The switch 16 is attached to a place so as to be reliably pushed with a foot. For example, the footwear 12 is worked and a hole is provided, so that the switch 16 can be pushed from inside the footwear 12 with a foot. The structure is shown in a cross-sectional view of the footwear 12 in FIG. 1D. FIG 1D is a cross-sectional view taken along line P-P′ in FIG. 1C. The power of the reader/writer 13 can be supplied from the computer 21 through a cable 14, or from a battery or the like.

With the above configuration, the foot wearing the footwear 12 equipped with the reader/writer 13 is put on a part of the sheet 11, the reader/writer 13 transmits the radio signal 15 including an instruction which outputs positional information to the wireless chips 10 under the reader/writer 13. Then, the wireless chips 10 which have received the radio signal 15 transmit the radio signal 15 including positional information included in the wireless chips 10 to the reader/writer 13, and the reader/writer 13 receives the radio signal 15 including the positional information. The reader/writer 13 extracts the positional information from the radio signal 15 and stores it.

Subsequently, when the foot put on the sheet 11 is moved, the reader/writer 13 receives a radio signal 15 including positional information from different wireless chips 10 right under the reader/writer, extracts positional information from the radio signal 15, and stores it. The reader/writer 13 calculates the distance traveled by the reader/writer 13 due to the movement of the foot, the angle, and the speed from the former positional information and the latter positional information.

The information obtained by the reader/writer 13 is outputted to the computer 21. Further, when the switch 16 for selecting a file or the like is pushed, the reader/writer 13 outputs the calculated information with the selection information added to the computer 21. The information is used for moving the cursor 25 or selecting a file or the like and reflected in the display 20. Accordingly, by moving the foot wearing the footwear 12 equipped with the reader/writer 13, the operation of the cursor 25 and the operation of selecting a file or the like by pushing the switch 16 can be performed.

Thus, in accordance with this embodiment mode, the operation of the cursor or the selection operation of a file or the like can be performed with a foot simultaneously with other manual operations. Accordingly, operations such as soldering or a printed substrate test which occupies hands can be simultaneously conducted while checking data of a circuit diagram or the like stored in the computer 21.

### Embodiment Mode 2

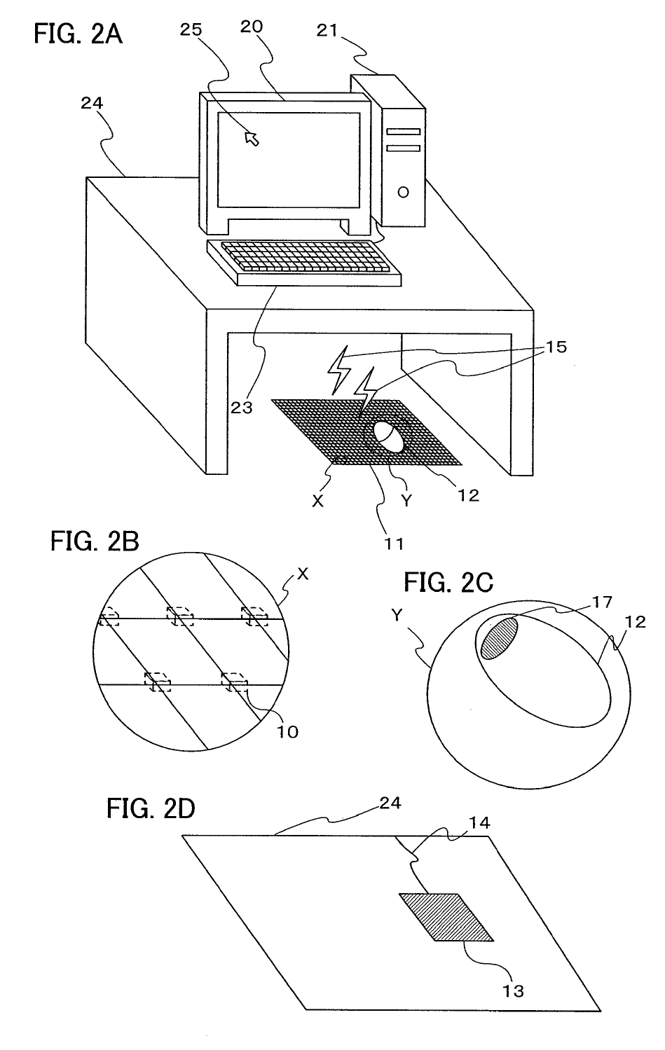

In this embodiment mode, Embodiment Mode 2 of the invention will be described with reference to FIGS. 2A to 2D.

FIG. 2A is an explanatory drawing which explains a configuration in which an input system using a radio signal 15 is provided under a desk 24 on which a computer 21 is disposed, and an operator of computer 21 wears a footwear 12 fitted with a radio signal blocking material 17 attached, and moves the foot, thereby achieving operation of a cursor 25 similarly to the case where a mouse 22 is operated with a hand. Note that this explanatory drawing shows the case of wearing the footwear 12 with a right foot; however, the invention is not limited thereto, and it may be worn on a left foot.

In FIG. 2A, wireless chips 10 (or wireless tags) manufactured by forming a semiconductor integrated circuit and an antenna over a single crystal substrate of silicon or the like, or a glass substrate, or a flexible substrate, and a reader/writer 13 which communicates with the wireless chips 10 using a radio signal 15 are used for an input system using the radio signal 15. Then, a plurality of wireless chips 10 storing positional information are prepared, and the wireless chips 10 are embedded into a sheet 11 formed of an insulator as shown in FIG. 2B in accordance with the positional information included in the wireless chips 10. FIG. 2B is an enlarged view of X in FIG. 2A. This sheet 11 is laid on a floor with the surface provided with the wireless chips face up under the desk 24 on which the computer 21 is disposed. For example, the sheet 11 is preferably disposed so that a predetermined lateral direction of the sheet 11 is perpendicular to a longitudinal direction of a screen of the display 20. Note that it is not preferable that left and right of the sheet 11 are reversed. Note that there are no particular limitations on the size and the manner of disposition of the sheet 11. Further, the sheet 11 may be attached to the floor with a seal or an adhesive tape, or the like.

Since a plurality of wireless chips 10 are used here, the reader/writer 13 may simultaneously receive a plurality of radio signals 15. When the radio signals 15 are simultaneously received, radio signals 15 impinge on each other, and correct information cannot be extracted from the radio signals 15. Therefore, as a method of preventing this, the output timing of the radio signals 15 of the wireless chips 10 is set so that the wireless chips 10 do not impinge on each other.

Meanwhile, the reader/writer 13 for transmitting the radio signals 15 including instructions which output positional information to the wireless chips 10, and for receiving the radio signals 15 including positional information from the wireless chips 10 is provided on the undersurface of the desk 24 as shown in FIG. 2D. FIG. 2D is a figure showing the undersurface of the desk 24 in FIG. 1A. The reader/writer 13 is connected to the computer 21 by wireless communication using a cable 14 or by wireless communication using infrared radiation or the like.

Further, as shown in FIG. 2C, a radio signal blocking material 17 is attached to the undersurface of the footwear to interrupt transmission/reception of the radio signals 15 between the reader/writer 13 and the wireless chips 10. FIG. 2C is a figure showing Y in FIG. 2A, and is a figure of the undersurface of the footwear 12. Here, the radio signal blocking material 17 is preferably attached to the undersurface of the footwear 12 to reliably block the radio signals 15. In addition, any material can be applied to the radio signal blocking material 17 as long as it blocks the radio signals 15, so a conductive plate may be used. Accordingly, weight is reduced, and strain on the foot and body can easily be avoided.

Further, a keyboard 23 is provided with at least one button for the exclusive use of selecting the mouse 22.

With the above configuration, the radio signals 15 including instructions which output positional information are transmitted from the reader/writer 13 to all the wireless chips 10 arranged on the sheet 11. Hereupon, when the footwear 12 with the radio signal blocking material 17 attached is worn on a foot and the footwear is put on a part of the sheet 11, transmission/reception of the radio signals 15 between the reader/writer 13 and wireless chips 10 right under the radio signal blocking material 17 is blocked by the radio signal blocking material 17. Accordingly, the reader/writer 13 cannot receive radio signals from the wireless chips 10 right under the radio signal blocking material 17. However, the radio signals other than ones in the wireless chips 10 right under the blocking material 17 can be received.

The reader/writer 13 identifies the positional information included in the radio signals 15 which could not be received using the positional information included in the plurality of radio signals 15 which have been received, so that the current position of the radio signal blocking material 17 is determined, and the positional information is stored.

Next, when the footwear 12 on the sheet 11 is moved, the reader/writer 13 transmits the radio signals 15 including instructions which output positional information to the surrounding wireless chips 10 based on the positional information just stored. Then, again there are unreceivable radio signals 15 which are blocked by the radio signal blocking material 17 and the rest of receivable radio signals 15 which are not blocked; accordingly, the current position of the radio signal blocking material 17 is determined using a plurality of pieces of positional information included in the radio signals 15, and is stored. The distance traveled by the radio signal blocking material 17 due to the movement of the foot, the angle, and the speed are calculated from positional information calculated previously and positional information calculated newly.

The reader/writer 13 outputs the calculated information to the computer 21. The information is used for the movement of the cursor 25, and is reflected in the display 20. Accordingly, the cursor 25 can be operated by moving the foot wearing the footwear 12 with the radio signal blocking material 17 attached.

Thus, in accordance with this embodiment mode, the operation performed by an operator in operating the cursor 25 can be simplified. Therefore, cost can be reduced, and strain on the foot and body can be lightened.

### Embodiment Mode 3

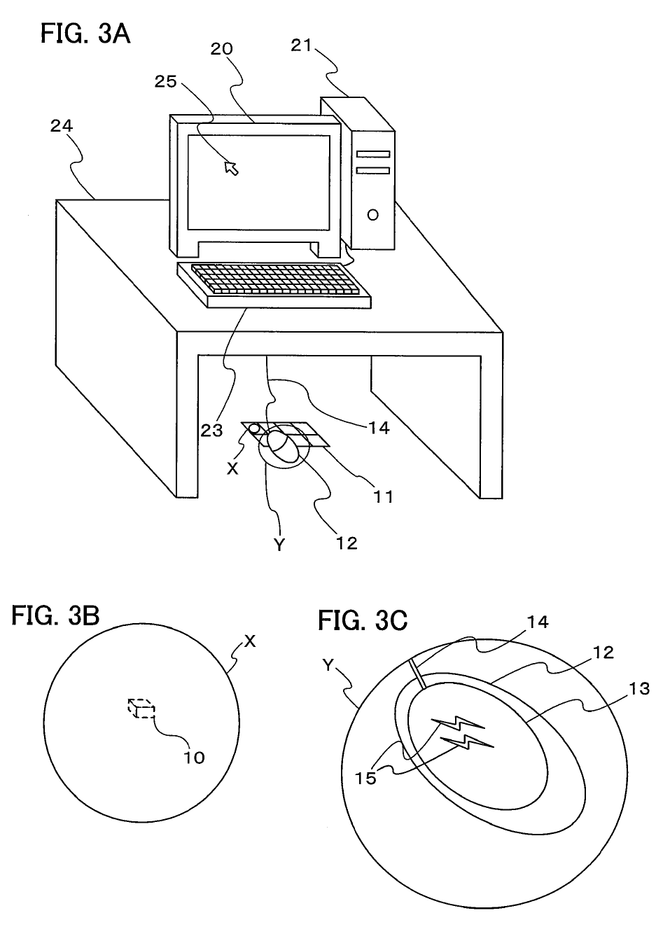

In this embodiment mode, Embodiment Mode 3 of the invention will be described with reference to FIGS. 3A to 3C.

FIG. 3A is an explanatory drawing which explains a configuration in which when an input system using the radio signal 15 is provided on the computer 21, an operator of the computer 21 operates a keyboard 23 by hand, and text is inputted and characters are converted; the text input or character conversion can be assisted by moving a foot wearing a footwear 12 (an operation device) with a reader/writer 13 attached. Note that in the explanatory drawing, the case where the footwear 12 is worn on a left; however, it is not limited thereto, and it may be worn on a right foot.

In FIG. 3A, wireless chips 10 (or wireless tags) manufactured by forming a semiconductor integrated circuit or the like and an antenna over a single crystal substrate of silicon or the like, or a glass substrate or a flexible substrate, and a reader/writer 13 which communicates with the wireless chips 10 using a radio signal 15 are used for an input system using the radio signal 15. The plurality of wireless chips 10 are prepared and embedded in a sheet 11 formed of an insulator as shown in FIG. 3B. FIG. 3B is an enlarged view of X in FIG. 3A. This sheet 11 is laid on a floor with the surface provided with the wireless chips face up under the desk 24 on which the computer 21 is disposed. For example, the sheet 11 is preferably disposed so that a predetermined lateral direction of the sheet 11 is parallel to a longitudinal direction of a screen of the display 20. Note that it is not preferable that left and right of the sheet 11 are reversed. Note that there are no particular limitations on the size and the manner of disposition of the sheet 11. Further, the sheet 11 may be attached to the floor with a seal, an adhesive tape, or the like. Here, the wireless chips 10 equally spaced and arranged store a function of inputting text, a function of a control key, a function of a shift key and the like as information. Functions to be used are different depending on operators, so that it is preferable to have it such that operators can set the functions arbitrarily.

Meanwhile, as shown in FIG. 3C, the wireless chips 10 and the reader/writer 13 which transmits and receives the radio signals 15 are attached on the undersurface of the footwear 12. FIG. 3C is a figure showing Y in FIG. 3A, and is a figure showing the undersurface of the footwear 12. Here, in order to receive the radio singles 15 reliably, it is preferable to attach it to the undersurface of the foot wear 12. The power of the reader/writer 13 can be supplied from the computer 21 through a cable 14, or from a battery or the like. Further, the footwear 12 may have a structure in which only an antenna portion of the reader/writer 13 is attached, the parts of the reader/writer 13 other than the antenna are provided elsewhere, and they are connected through a cable 14. With this structure, the actual operating weight of the footwear 12 can be reduced and strain on the foot and body can be lightened, which is preferable.

Further, for the operation of the cursor 25 using the mouse 22, this embodiment mode can be combined with the above embodiment modes.

With the above configuration, when a foot wearing the footwear 12 equipped with the reader/writer 13 is put on a part of the sheet 11, the reader/writer 13 transmits radio signals 15 including instructions which output function information to the wireless chips 10 directly underneath the reader/writer 13. Then, the wireless chips 10 which received the radio signals 15 transmit the radio signals 15 including function information to the reader/writer 13, and the reader/writer 13 receives the radio signals 15 including the information.

The reader/writer 13 outputs the received function information to the computer 21. Here, the information inputted to the computer 21 is processed by the computer 21 and is reflected in the display 20 or the like. Accordingly, text input or character conversion can be performed by moving a foot wearing the footwear 12 with the reader/writer 13 attached.

Thus, by providing a control key and a shift key provided on the keyboard 23 are provided on an input system operated with a foot, since shortcut operations, changing operation between uppercase and lowercase of alphabets and the like can be performed more quickly, the operation efficiency can be improved.

### Embodiment Mode 4

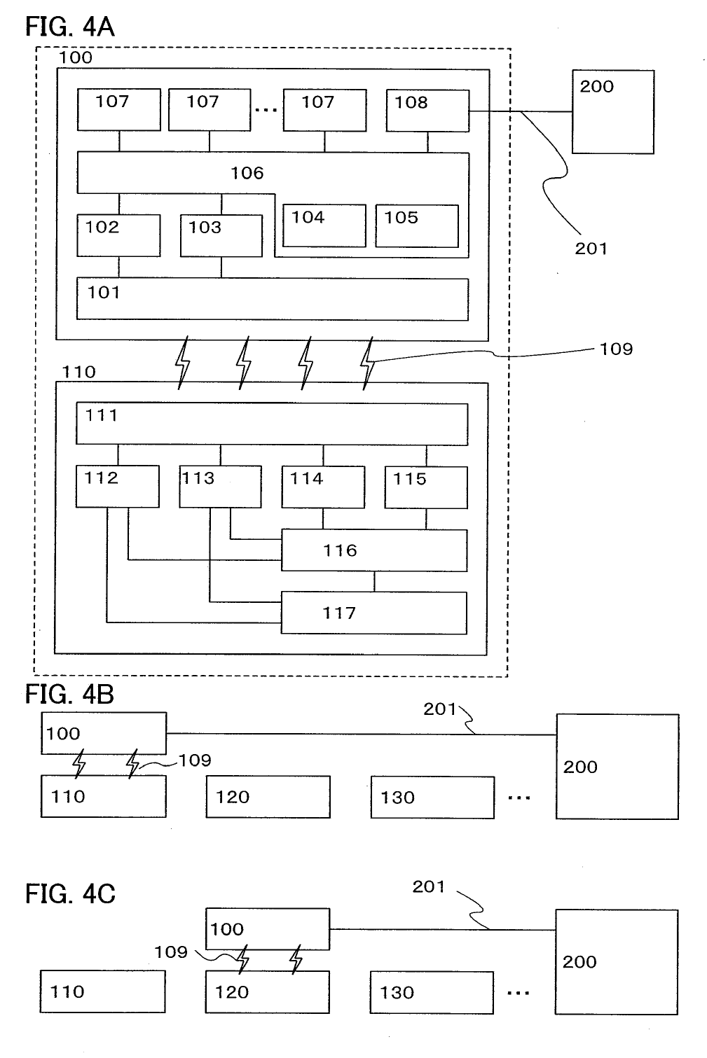

In this embodiment mode, Embodiment Mode 4 different from the above embodiment modes will be described with reference to FIGS. 4A to 4C.

FIG. 4A is a block diagram showing a configuration of the invention. An input system of the invention includes wireless chips (or wireless tags) 110, 120, and 130 manufactured by forming a semiconductor integrated circuit or the like and an antenna over a silicon substrate, a glass substrate, or a plastic substrate, and a reader/writer 100 which transmits/receives a radio signal 109 with the wireless chip 110. Further, the reader/writer 100 is connected to a computer 200 by wire communication using a cable 201, or by wireless communication using infrared radiation or the like.

As shown in FIG. 4A, the reader/writer 100 of the invention includes an antenna 101, a modulation circuit 102, a demodulation circuit 103, a control unit 106 having a memory unit 104 and an arithmetic logical unit 105, switches 107 each having a function of selecting text or a file, and an input-output unit 108. It is preferable if an operator can arbitrarily assign a function to each switch 107, because the operation efficiency is improved. The input-output unit 108 is connected to the computer 200 by wire communication using the cable 201, or wireless communication using infrared radiation or the like.

In the case where cursor operation is performed using an input system of the invention, an instruction for inquiring a cursor position is transferred from the computer 200 to the reader/writer 100 by wire communication using the cable 201 or wireless communication using infrared radiation or the like. The input-output unit 108 of the reader/writer 100 receives the instruction and transfers it to the control unit 106.

Here, if the cursor position is at a position of the reader/writer 100, information of a position stored in a wireless chip nearest to the reader/writer 100, shows the position of the reader/writer 100. As shown in FIG. 4B, here, the nearest wireless chip is referred to as the wireless chip 110. The reader/writer 100 receives the instruction for inquiring the cursor position from the computer, and the instruction is analyzed with the control unit 106, and then the reader/writer 100 transmits an instruction for reading positional information to the wireless chip 110.

The control unit 106 generates a signal in which the instruction for reading position information is encoded, and it is transferred to the modulation circuit 102. The modulation circuit 102 modulates carrier based on the encoding signal and outputs it to the antenna 101, and the antenna 101 transmitted as the radio signal 109 to the wireless chip 110.

The wireless chip 110 which received the radio signal 109 extracts the instruction included in the radio signal 109 and then analyzes it.

The wireless chip 110 of the invention includes a resonant circuit 111 having an antenna and a resonant capacitor, a power supply circuit 112, a clock circuit 113, a modulation circuit 114, a demodulation circuit 115, a control circuit 116, and a memory circuit 117. The wireless chip 110 is not limited to the structure, and may have a central processing unit (CPU), a congestion control circuit, an AD converting circuit, and the like in addition.

A non-writable nonvolatile memory, a mask ROM (Read Only Memory), a write-once memory having an insulator between electrodes can be used for a memory element provided in the memory circuit 117. As a rewritable nonvolatile memory, a flash memory, an EEPROM (Electrically Erasable Programmable Read Only Memory), a ferroelectric memory, or the like can be used.

When the wireless chip 110 receives the radio signal 109 transmitted from the antenna 101 of the reader/writer 100 using the resonant circuit 111, alternating current signals are generated at either end of the antenna 101. The power supply circuit 112 generates power supply potential based on the generated alternating current signal and supplies it to each circuit, and in addition, the clock circuit 113 generates clock signals having different frequencies, and supplies them to each circuit.

Further, the generated alternating current signal generated in the resonant circuit 111, includes information such as an instruction which is transmitted from the antenna 101 of the reader/writer 100, the demodulation circuit 115 demodulates information included in the alternating current signal. The control circuit 116 extracts the instruction from the demodulated signal, and a series of operations are performed in accordance with the instruction by controlling the memory circuit 117. Further, a circuit for checking whether the demodulated signal has an error or not may be provided.

The memory circuit 117 holds information unique to the wireless chip 110. Here, the unique information corresponds to positional information showing where the wireless chip 110 is disposed, set function information, or the like.

In this case, the instruction extracted by the control circuit 116 is an instruction for reading positional information; thus, the control circuit 116 transmits the instruction for reading positional information to the memory circuit 117, thereby reading positional information. The control circuit 116 generates a signal in which the read information is encoded by an encoding circuit in the control circuit 116, and outputs the modulation circuit 114.

The modulation circuit 114 has a function of modulating carrier based on the encoded signal. Then, the modulation circuit 114 modulates the encoding signal inputted by the control circuit 116, and outputs it to the resonant circuit 111 having the antenna 101.

The antenna 101 transmits the alternating current signal inputted into the resonant circuit 111 by the modulation circuit 114 is transmitted as a radio signal 109 to the reader/writer 100.

The radio signal 109 including positional information from this wireless chip 110 is received by the antenna 101 of the reader/writer 100. The antenna 101 of the reader/writer 100 outputs the received radio signal 109 to the demodulation circuit 103. The demodulation circuit 103 demodulates the radio signal 109 and outputs it to the control unit 106.

The control unit 106 extracts positional information from the demodulated signal, and stores it in the memory unit 104 of the control unit 106, and further transfers it to the arithmetic logical unit 105. The arithmetic logical unit 105 compares previously received positional information (first positional information) and newly received positional information (second positional information).

In this case, the arithmetic logical unit 105 is not required to compare since there is not the previous positional information. In the case of comparing, the result of comparison is outputted to the input-output unit 108. However, since the comparison was not conducted this time, information showing the fact is outputted to the input-output unit 108. The input-output unit 108 transfers the information to the computer 200.

The position of a cursor is determined by the computer 200 based on the information and reflected in a display. Then, an instruction for inquiring a cursor position is again transferred from the computer 200 to the reader/writer 100 by wire communication using the cable 201 or wireless communication using infrared radiation or the like.

The reader/writer 100 which received the instruction transmits the radio signal 109 including an instruction for reading positional information to the wireless chips. Here, as shown in FIG. 4B to FIG. 4C, in the case where the position of the reader/writer 100 moves and a wireless chip 120 is the nearest wireless chip in place of the wireless chip 110, the reader/writer 100 which received the instruction for inquiry transmits the radio signal 109 including the instruction for reading positional information to the wireless chip 120.

The wireless chip 120 which received the radio signal 109 performs the same operation as the wireless chip 110 explained above, and transmits the radio signal 109 including the positional information stored in the wireless chip 120 to the reader/writer 100.

This reader/writer 100 which received the radio signal 109 extracts positional information from the radio signal 109 using the control unit 106 and transfers it to the memory unit 104 and the arithmetic logical unit 105. The memory unit 104 stores the positional information. Then, the memory unit 104 transfer the previously stored positional information to the arithmetic logical unit 105. Accordingly, since the arithmetic logical unit 105 receives newly extracted positional information and the previously stored positional information, and compares the two pieces of information. By comparing the two pieces of information, the distance traveled by the reader/writer 100, the angle, and the speed are calculated.

The control unit 106 outputs the result to the input-output unit 108. Further, if the switch 107 is pushed, information showing that the switch was pushed is also added by the control unit 106 and outputted to the input-output unit. The input-output unit 108 transfers the information to the computer 200.

Here, the computer 200 determines the cursor position based on the received information and reflects it in a display. A plurality of wireless chips is prepared and the series of operations are repeated, an input system of the invention can achieve cursor operation.

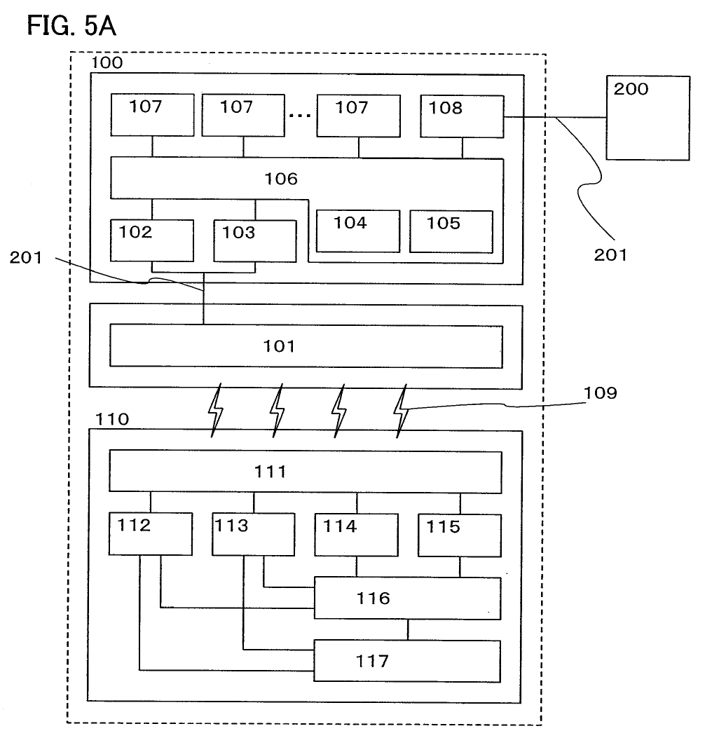

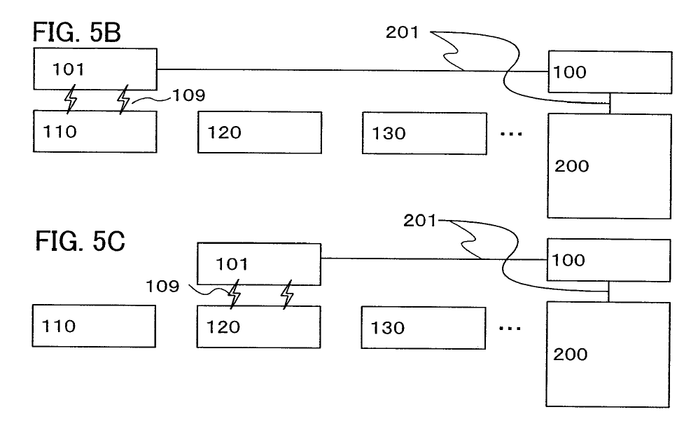

This embodiment mode has explained an example of a series of exchanges between the wireless chips 110 and 120, and the reader/writer 100; however, the present invention is not limited on this mode. For example, as shown in FIGS. 5A, 5B, and 5C, a configuration in which the reader/writer 100 is fixed, and only the antenna 101 part may also be employed for the series of exchanges.

### Embodiment Mode 5

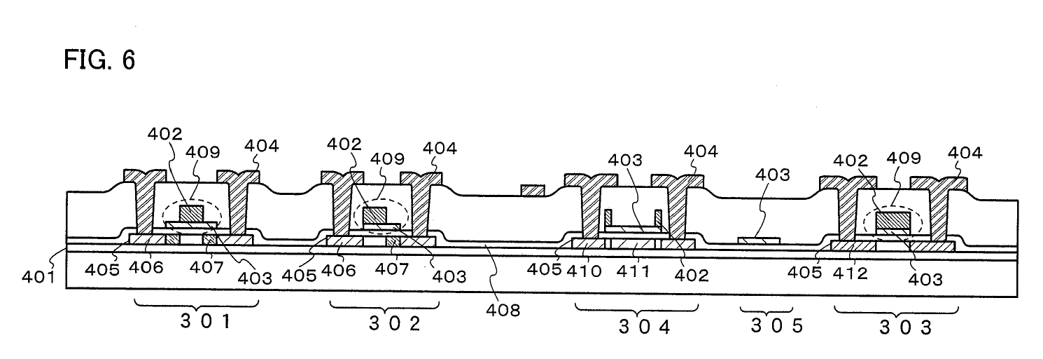

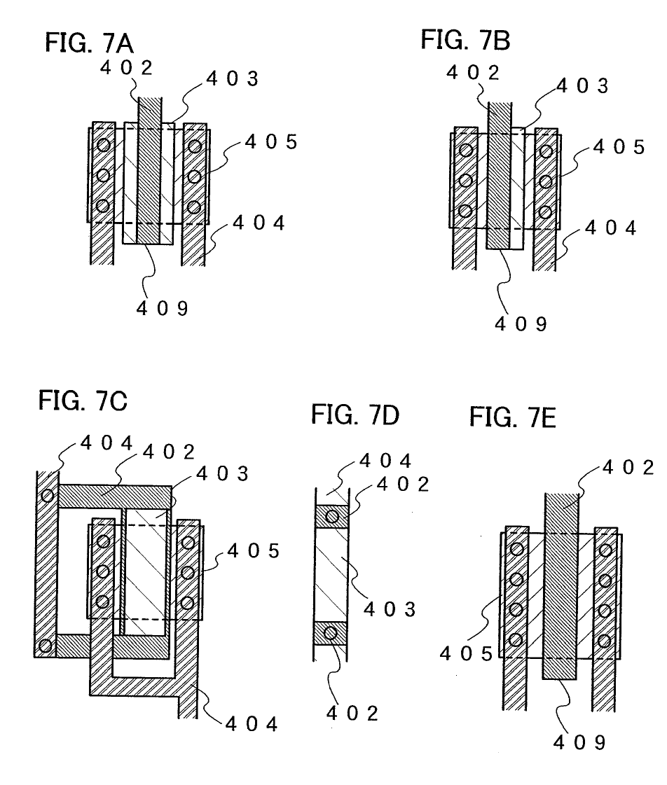

In this embodiment mode, structures of a transistor, a capacitor element, and a resistor element partially composing each circuit of a wireless chip will be described with reference to FIG. 6 and FIGS. 7A to 7E.

Each circuit forming the wireless chips 110, 120, and 130 shown in the above embodiment mode has a structure including a transistor. The transistor can be formed using a MOS transistor formed over a single crystal substrate of silicon or the like, or a thin film transistor (TFT) on which a glass substrate or a plastic substrate is formed over a base film 401 or the like. FIG. 6 shows a cross-sectional structure of such a circuit included in a transistor. FIG. 6 shows an n-channel transistor 301, an n-channel transistor 302, a capacitor element 304, a resistor element 305, and a p-channel transistor 303. Each transistor can be used for a thin film transistor (TFT) having a semiconductor layer 405, an insulating layer 408, a gate electrode 409. The gate electrode 409 is formed in a layered structure having a first conductive layer 403 and a second conductive layer 402. Further, FIGS. 7A to 7E are top views of the n-channel transistor 301, n-channel transistor 302, capacitor element 304, resistor element 305, and p-channel transistor 303 shown in FIG. 6, which are collectively shown.

In FIG. 6, in the n-channel transistor 301 an impurity region 407 also referred to as a lightly doped drain (LDD) is provided below opposite sides of the gate electrode in a channel length direction (carrier flow direction) in a semiconductor layer 405, which is doped at a lower concentration than an impurity concentration of an impurity region 406 forming source and drain regions which make a contact with a wiring 404. When the n-channel transistor 301 is formed, the impurity region 406 and the impurity region 407 are doped with phosphorus or the like as an impurity which imparts n-type conductivity. The LDD can suppress hot electron degradation or a short channel effect.

As shown in FIG. 7A, in the gate electrode 409 of the n-channel, transistor 301, the first conductive layer 403 is formed so as to spread on either side of the second conductive layer 402. In this case, the first conductive layer 403 is formed to have thinner thickness than the second conductive layer 402. The first conductive layer 403 is formed to have a thickness so that through which ion species accelerated by the electric field of 10 kV to 100 kV can pass. The impurity region 407 is formed to overlap the first conductive layer 403 of the gate electrode 409. Specifically, an LDD region overlapping the gate electrode 409 is formed. In this structure, the gate electrode 409 is doped with an impurity having one conductivity type through the first conductive layer 403 using the second conductive layer 402 as a mask thereby forming the impurity region 407 in a self aligned manner. Accordingly, an LDD overlapping the gate electrode 409 is formed.

A transistor having an LDD on either side is applied to a TFT for rectifying a power circuit 112 of the wireless chip 110 shown in FIG. 4A or a transistor forming a transmission gate (also referred to as an analog switch) used for a logic circuit. As to such a TFT, either positive or negative voltage is applied to a source electrode or a drain electrode; therefore, it is preferable to provide an LDD on either side of the gate electrode.

In FIG. 6, in the n-channel transistor 302, the impurity region 407 doped at a lower concentration than an impurity concentration of the impurity region 406 is formed in the semiconductor layer 405. As shown in FIG. 7B, in the gate electrode 409 of the n-channel transistor 302, the first conductive layer 403 is formed so as to spread to one side of the second conductive layer 402. Similarly in this case, an LDD can be formed by adding an impurity having one conductivity type through the first conductive layer 403 using the second conductive layer 402 as a mask.

A transistor having an LDD on one side may be applied to a transistor in which only one of positive voltage or negative voltage is applied between the source and drain electrodes. Specifically, a transistor forming a logic gate such as an inverter circuit, a NAND circuit, an NOR circuit, or a latch circuit, or a transistor forming an analog circuit such as a sense amplifier, a constant voltage generating circuit, or a VCO (Voltage Control Oscillator).

In FIG. 6, the capacitor element 304 is formed to sandwich the gate insulating layer 408 between the first conductive layer 403 and the semiconductor layer 405. The semiconductor layer 405 forming the capacitor element 304 includes an impurity region 410 and an impurity region 411. The impurity region 411 is formed at a position overlapping the first conductive layer 403 in the semiconductor layer 405. Further, the impurity region 410 makes a contact with the wiring 404. The impurity region 411 can be doped with an impurity having one conductivity type through the first conductive layer 403; therefore, impurity concentrations of the impurity region 410 and the impurity region 411 can be made the same or different. In either case, in the capacitor element 304, since the semiconductor layer 405 functions as an electrode, the semiconductor layer 405 is preferably reduced in resistance by adding an impurity having one conductivity type. Further, the first conductive layer 403 can be used as an electrode sufficiently by using the second conductive layer 402 as a complementary electrode as shown in FIG. 7C. Accordingly, a capacitor element 304 can be formed in a self-aligned manner using a composite structure in which the first conductive layer 403 and the second conductive layer 402 are combined.

The capacitor element is used as a storage capacitor in a power supply circuit 112 of the wireless chip 110, or a resonant capacitor of the resonant circuit 111 in FIG. 4A. In particular, either positive or negative voltage is applied between two terminals of the capacitor element of the resonant capacitor; therefore, it is necessary that the resonant capacitor functions as a capacitor irrespectively of the polarity of the voltage between the two terminals.

In FIG. 6, the resistor element 305 is formed using the first conductive layer 403. The first conductive layer 403 is formed to a thickness of approximately 30 nm to 150 nm, the width or the length may be determined as appropriate to form the resistor element.

The resistor element is used as a resistance load of the modulation circuit 114 of the wireless chip 110 in FIG. 4A Further, it can be used as a load of the case where current is controlled by VCO or the like. The resistor element may be formed using a semiconductor layer containing an impurity element at a high concentration, or a metal layer having thin film thickness. The resistance value of a semiconductor layer is determined depending on the film thickness, film quality, impurity concentration, activation ratio, and the like. Whereas the resistance value of the metal layer is determined depending on the film thickness and film quality, so that the fluctuation is small, which is preferable.

In FIG. 6, in the p-channel transistor 303, the semiconductor layer 405 is provided with an impurity region 412. This impurity region 412 forms source and drain regions which make contacts with the wiring 404. The gate electrode 409 has a configuration in which the first conductive layer 403 and the second conductive layer 402 overlap each other. The p-channel transistor 303 is a transistor having a single drain structure without an LDD. In the case of forming the p-channel transistor 303, the impurity region 412 is doped with boron or the like as an impurity imparting a p-type conductivity. Meanwhile, if the impurity region 412 is doped with phosphorus, an n-channel transistor having a single drain structure can be formed.

One or both of the semiconductor layer 405 and the gate insulating layer 408 may be oxidized or nitrided by high density plasma treatment excited by a microwave at an electron temperature of 2 eV or less, an ion energy of 5 eV or less, an electron density of 10¹¹/cm³ to 10¹³/cm³ approximately. Here, since the substrate temperature may be 300° C. to 450° C., the layer can be formed on a substrate of plastic which has low resistance to heat.

Film formation atmosphere of such an insulating film can be a nitrogen atmosphere or an oxygen atmosphere. A nitrogen atmosphere generally means a mixed atmosphere of nitrogen and a rare gas, or a mixed atmosphere of nitrogen, hydrogen and a rare gas. At least one of helium, neon, argon, krypton, or xenon can be used as a rare gas. Further, an oxygen atmosphere generally means a mixed atmosphere of oxygen and a rare gas, a mixed atmosphere of oxygen, hydrogen, and a rare gas, or a mixed atmosphere of dinitrogen monoxide and a rare gas. At least one of helium, neon, argon, krypton, or xenon can be used as a rare gas.

By treatment in an oxygen atmosphere or a nitrogen atmosphere, defect level of an interface between the semiconductor layer 405 and the gate insulating layer 408 can be reduced. When the gate insulating layer 408 is subjected to this treatment, this insulating layer can be densified. Accordingly, generation of charge defect is suppressed to reduce change in the threshold voltage of a transistor. Further, in the case where the transistor is driven at a voltage of 3 V or less, an insulating layer oxidized or nitrided by this plasma treatment can be applied as the gate insulating layer 408. Further, in the case where the transistor is driven at a voltage of 3V or more, an insulating layer formed on a surface of the semiconductor layer 405 by plasma treatment and an insulating layer deposited by CVD (plasma CVD or thermal CVD) can be combined to form the gate insulating layer 408. Further, alternatively, this insulating layer can be used as a dielectric layer of the capacitor element 304. In this case, an insulating layer formed by this plasma treatment has a thickness of 1 nm to 10 nm to be a dense film; thus, a capacitor element having capacity to charge highly can be formed.

Further, amorphous silicon or polycrystalline silicon can be used for the semiconductor film. In the case of using polycrystalline silicon, amorphous silicon is formed first, and it can be crystallized by heat treatment or laser irradiation to form polycrystalline silicon. Here, a metal element typified by nickel can be used for heat treatment or laser irradiation, thereby lowering the crystallization temperature. A continuous-wave or pulsed laser irradiation apparatus can be used for the laser irradiation. Alternatively, a crystallization method by heat treatment and a crystallization method using a continuous wave laser beam or a laser beam which is emitted at a frequency of 10 MHz or more may be combined. By irradiating the continuous wave laser or the laser beam which oscillates at a frequency of 10 MHz or more, the surface of the semiconductor film which is crystallized can be made flat. Accordingly, the gate insulating film can also be made thin and the resistance to pressure of the gate insulating film can be improved.

In addition, the semiconductor film which is obtained by crystallizing a semiconductor film by irradiation with the continuous wave laser or the laser beam which is emitted at a frequency of 10 MHz or more moved in one direction, has a characteristic such that crystals are grown in the scanning direction of the beam. By arranging transistors in a channel length direction (carrier flow direction at a time when a channel forming region is formed) aligned with the scanning direction, and combining it with a gate insulating film subjected to high density plasma treatment, transistors (TFT) in which characteristic variation is small and field-effect mobility is high can be obtained.

As described with reference to FIG. 6 and FIGS. 7A to 7E, by combining conductive layers having different thicknesses, elements having various structures can be formed. A region where only the first conductive layer is formed and a region where the first conductive layer and the second conductive layer are stacked can be formed using a photomask or a reticle which is provided with a diffraction grating pattern or an auxiliary pattern having an optical intensity reducing function formed of a semitransparent film. That is, in a photolithography process, the quantity of light transmitted through the photomask is controlled in exposing the photoresist so that the thickness of a resist mask to be developed is varied. In other words, a slit at the resolution limit or less may be provided in the photomask or the reticle to form the above-described resist having a complex shape. In addition, by baking at about 200° C. after the development, the shape of a mask pattern made from a photoresist material can be changed.

In addition, by using the photomask or the reticle which is provided with a diffraction grating pattern or an auxiliary pattern having an optical intensity reducing function formed of a semitransparent film, the region where only the first conductive layer is formed and the region where the first conductive layer and the second conductive layer are stacked can be formed in succession. As shown in FIG. 7A, the region where only the first conductive layer 403 is formed can be formed selectively over the semiconductor layer. Such a region is effective over the semiconductor layer, but is not required in the other region (a wiring region which is successive to the gate electrode). Since the region where only the first conductive layer 403 is formed is not required to be formed in the wiring region by using this photomask or reticle, wiring density can be improved substantially.

In the case of FIG. 6 and FIGS. 7A to 7E, the first conductive layer is formed of a high melting point metal such as tungsten (W), chromium (Cr), tantalum (Ta), tantalum nitride (TaN) or molybdenum (Mo), or an alloy or a compound containing the high melting point metal as its main component to a thickness of 30 nm to 50 nm. In addition, the second conductive layer is formed of a high melting point metal such as tungsten (W), chromium (Cr), tantalum (Ta), tantalum nitride (TaN) or molybdenum (Mo), or an alloy or a compound containing the high melting point metal as its main component to a thickness of 300 nm to 600 nm. For example, different conductive materials are used for the first conductive layer and the second conductive layer respectively so that there occurs difference in etching rates therebetween in a later etching process. As an example, TaN can be used for the first conductive layer and a tungsten film can be used for the second conductive layer.

Further, in the case where a gate wiring is formed using the second conductive layer, the first conductive layer may be patterned so as to be aligned to the either end thereof. Accordingly, a fine gate wiring can be formed. In addition, an LDD overlapping the gate electrode is not required to be formed in a self-aligned manner.

In accordance with this embodiment mode, transistors having different electrode structures, a capacitor element, and a resistor element can be formed separately in the same patterning process by using the photomask or the reticle which is provided with a diffraction grating pattern or an auxiliary pattern having an optical intensity reducing function formed of a semitransparent film. Accordingly, in accordance with circuit characteristics, elements having different modes can be formed without increasing the number of steps, and integrated.

### Embodiment Mode 6

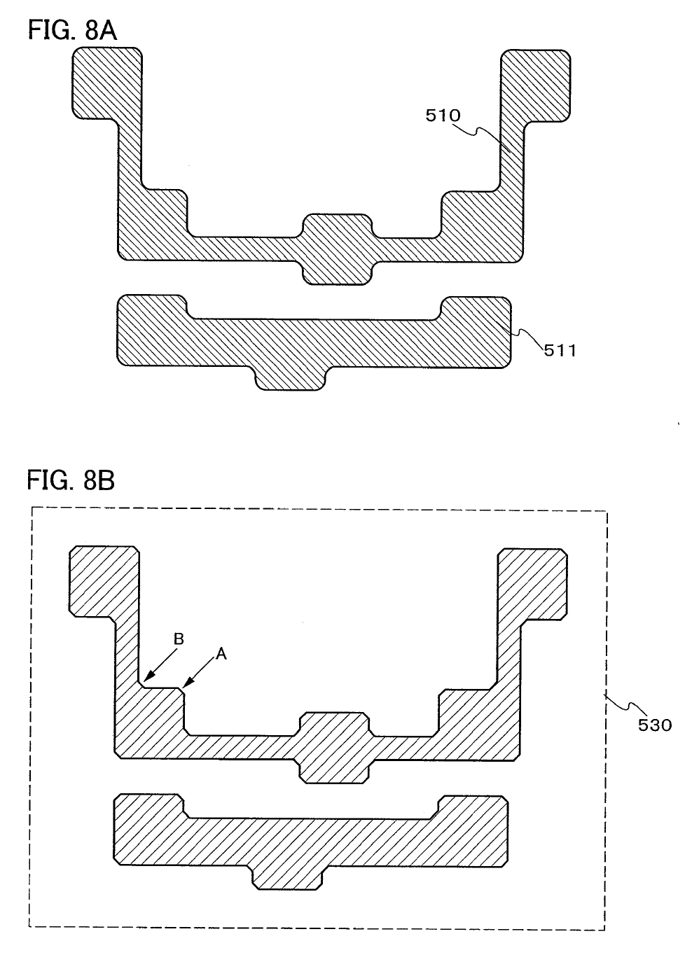

In this embodiment, an example of forming a memory circuit as one component of a wireless chip shown in FIG. 4A will be described with reference to FIGS. 8A to 10B.

Semiconductor layers 510 and 511 shown in FIG. 8A are preferably formed of silicon or a crystalline semiconductor containing silicon as its component. For example, polycrystalline silicon obtained by crystallizing a silicon film by laser annealing or the like, single crystal silicon, or the like is used. Alternatively, a metal oxide semiconductor, amorphous silicon, or an organic semiconductor exhibiting a semiconducting characteristic can also be used.

In any case, a semiconductor layer to be formed first is formed over an entire surface of a substrate having an insulating surface or a part thereof (a region having area larger than an area which is determined as a semiconductor region of a transistor). Then, by a photolithography technology, a mask pattern is formed over the semiconductor layer. By carrying out etching treatment on the semiconductor layer with the mask pattern, island-shaped semiconductor layers 510 and 511 having a specific shape are formed which each include a source and drain region and a channel forming region of a TFT. The semiconductor layers 510 and 511 are determined in consideration of an appropriate layout.

A photomask for forming the semiconductor layers 510 and 511 shown in FIG. 8A has a mask pattern 530 shown in FIG. 8B. This mask pattern 530 is different depending on whether a resist to be used in the photolithography process is a positive type or a negative type. In the case where a positive type resist is used, the mask pattern 530 shown in FIG. 8B is formed as a light shielding portion. The mask pattern 530 has a shape where a vertex portion A of a polygon is eliminated. In addition, an inner side of a corner part B is bent plural times so as not to bend at right angle in a corner thereof. In this photomask pattern, for example, the corner part is eliminated.

The shape of the mask pattern 530 shown in FIG. 6B is reflected in the semiconductor layers 510 and 511 shown in FIG. 8A. In that case, the homothetic shape of the mask pattern 530 may be transferred, or may be transferred so that the corner part of the mask pattern 530 is rounder. In other words, a round portion in which the pattern shape is smoother than the photomask pattern 530 may be provided.

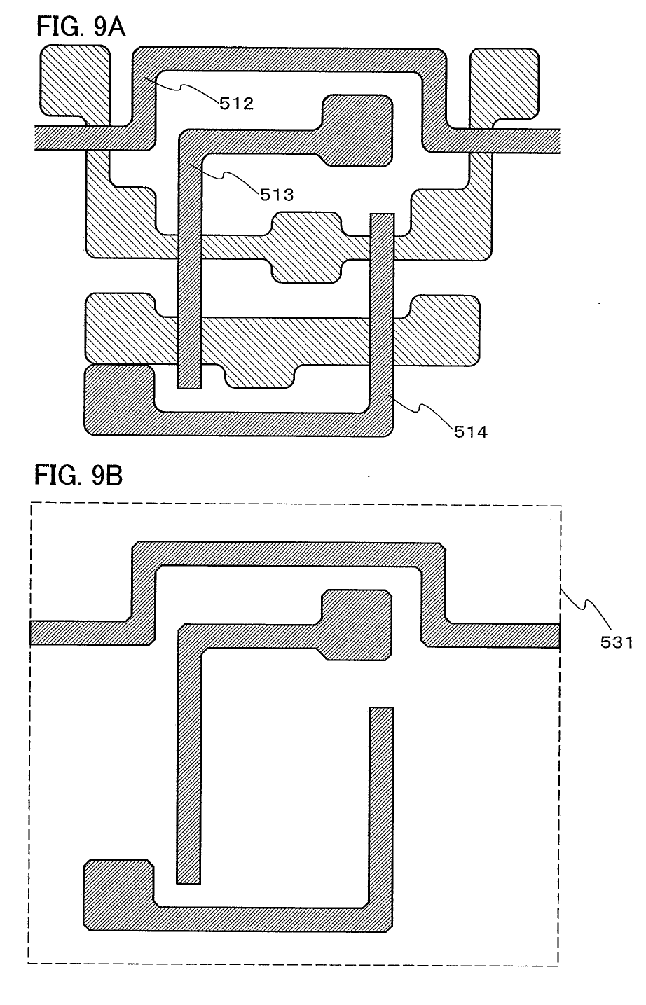

Over the semiconductor layers 510 and 511, an insulating layer at least partially containing silicon oxide or silicon nitride is formed. One purpose of forming this insulating layer is a gate insulating layer. Then, as shown in FIG. 9A, gate wirings 512, 513, and 514 are formed so as to partially overlap with the semiconductor layers. The gate wiring 512 is formed correspondingly to the semiconductor layer 610. The gate wiring 513 is formed correspondingly to the semiconductor layers 510 and 511. In addition, the gate wiring 514 is formed correspondingly to the semiconductor layers 510 and 511. As the gate wiring, a metal layer or a highly conductive semiconductor layer is formed, and the shape thereof is formed over the insulating layer by a photolithography technology.

A photomask for forming the gate wiring has a mask pattern 531 shown in FIG. 9B. In the photomask pattern 531, the corner part with a length of ⅕ to ½ of the linewidth of the wiring is eliminated. The shape of the mask pattern 531 shown in FIG. 9B is reflected in the gate wirings 512, 513, and 514 shown in FIG. 9A. In that case, a homothetic shape of the mask pattern 531 may be transferred to print, or may be transferred to print such that the corner part of the mask pattern 531 is more round. In other words, a round portion in which the pattern shape is smoother than the photomask pattern 531 may be provided in the gate wirings 512, 513, and 514. In an outer side of the corner part in the gate wirings 512, 513, and 514, generation of fines due to abnormal discharge can be suppressed when dry etching with plasma is conducted. In addition, even if fines are attached to the substrate, an inner side of the corner part makes it possible to wash away the fines when cleaning without retaining washing liquids in the corner part in the wire pattern.

An interlayer insulating layer is a layer which is formed subsequently to the gate wirings 512, 513, and 514. The interlayer insulating layer is formed of an inorganic insulating material such as silicon oxide or an organic insulating material using polyimide, acrylic resin, or the like. An insulating layer made from silicon nitride, silicon nitride oxide, or the like may be interposed between this interlayer insulating layer and the gate wirings 512, 513, and 514. Furthermore, an insulating layer made of silicon nitride, silicon nitride oxide, or the like may be provided over the interlayer insulating layer as well. This insulating layer can prevent an impurity which is not good for a TFT, such as an exogenous metal ion or moisture from contaminating the semiconductor layer or the gate insulating layer.

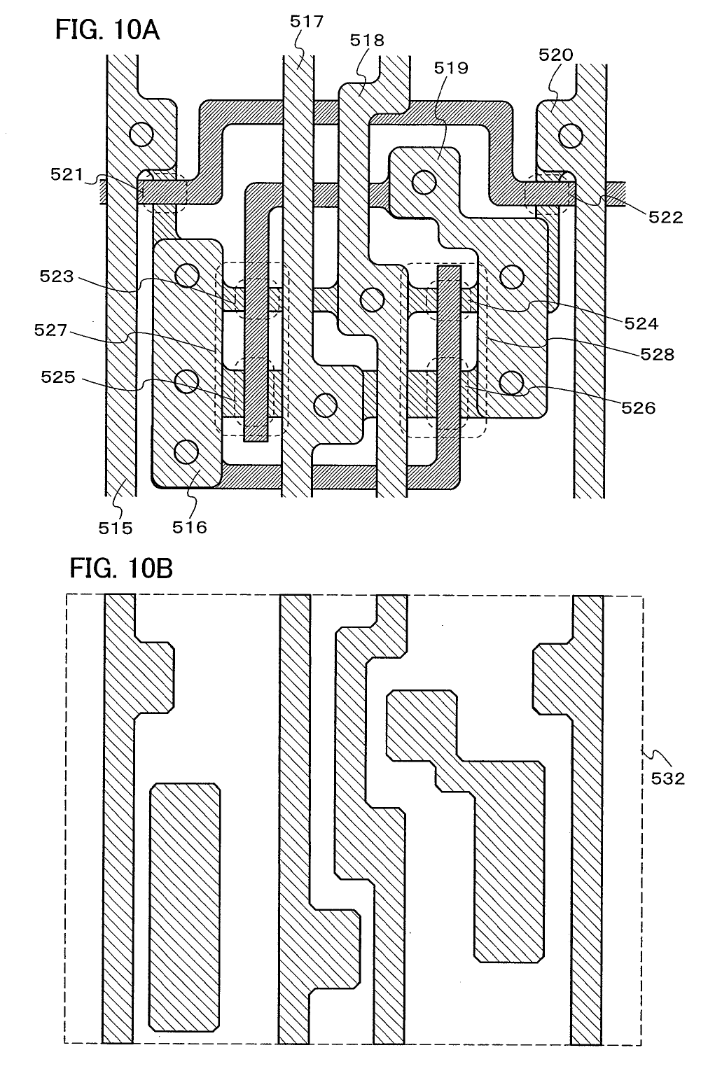

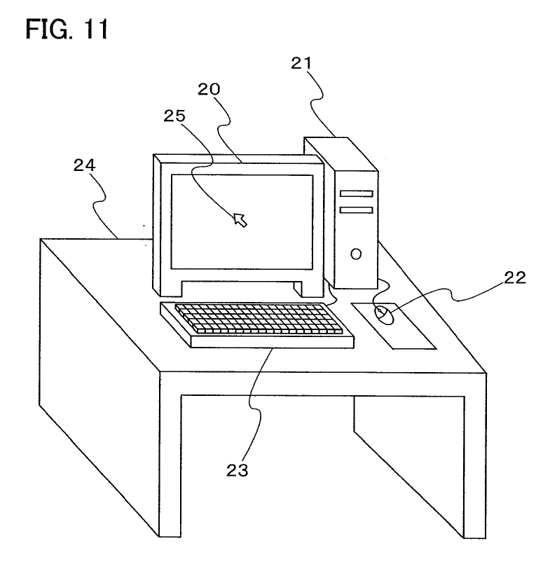

In the interlayer insulating layer, an opening is formed at a predetermined position. For example, it is provided correspondingly to the gate wiring or the semiconductor layer which is in the lower layer. As for the wiring layer which is formed of one layer or a plurality of layers made from a metal or a metal compound, a mask pattern is formed by photolithography technology to be a predetermined pattern by an etching process. Then, as shown in FIG. 10A, wirings 515 to 520 are formed so as to partially overlap with the semiconductor layer. With the wirings, predetermined elements can be connected to each other. The wirings do not connect the predetermined elements by a straight line but has a bending portion because of layout limitation. In addition, the width of the wiring is changed in width in the contact portion or another region. In the contact portion, when the contact hole is equal to or larger than the wiring width, the wiring width is changed to be wider at that portion.

A photo mask used for forming the wires 515 to 520 has a mask pattern 532 shown in FIG. 10B. In this case also, a corner of a corner part in the mask pattern is removed by a length of one-fifth to half the width of the wire so as to make a round corner part. That is to say, the circumference of the wiring layer in the edge is curved when seen from above. Specifically, in order to form a round circumference of the edge, a part of the wiring layer is removed, which corresponds to an isosceles right triangle having two first straight lines that are perpendicular to each other making the edge, and a second straight line that makes an angle of about 45 degrees with the two first straight lines. When removing the triangle, two obtuse angles are formed in the wiring layer. At this time, the wiring layer is preferably etched by appropriately adjusting the etching conditions and/or a mask design so that a curved line in contact with the first straight line and the second straight line is formed in each obtuse angle part. Note that the length of the two sides of the isosceles right triangle, which are equal to each other, is equal to or longer than one-fifth the width of the wiring layer and equal to or shorter than half the width of the wiring layer. In addition, the inner circumference of the edge is also made curved in accordance with the circumference of edge. With such a shape, generation of fines due to abnormal electrical discharge can be suppressed when dry etching by plasma is conducted. In addition, even if fines are attached to the substrate, an inner side of the corner part makes it possible to wash away the fines when cleaning without retaining washing liquid in the corner portion of the wire pattern. As a result, there is an effect that yield can be improved. Thus is also advantageous that when many parallel wires are provided over the substrate, fine powder attached to the substrate can be easily washed away. In addition, the round corner part of the wire can be expected to allow electrical conduction.

In FIG. 10A, n-channel transistors 521 to 524 and p-channel transistors 525 and 526 are formed. The n-channel transistor 523 and the p-channel transistor 525 compose an inverter. Also, the n-channel transistor 524 and the p-channel transistor 526 compose an inverter. A circuit including the six transistors forms a memory circuit. An insulating layer made of silicon nitride, silicon oxide, or the like may be formed in a layer over these transistors.

This application is based on Japanese Patent Application serial No. 2005-160751 filed in Japan Patent Office on May 31 in 2005, the entire contents of which are hereby incorporated by reference.

What is claimed is:

1. An input device for inputting a signal into an electric device, comprising:
a sheet on which a wireless chip capable of reading positional information by wireless communication recording the positional information are arranged and
a pointing device capable of wirelessly communicating with the wireless chip, which is movably disposed over the sheet.

2. An input device for inputting a signal into an electric device, comprising:
a sheet on which a plurality of wireless chips capable of reading positional information by wireless communication recording the positional information are arranged and
a pointing device capable of wirelessly communicating with the wireless chips, which is movably disposed over the sheet,
wherein the pointing device includes:
an analyzing portion of positional information for obtaining information of a position on the sheet by reading information in the plurality of wireless chips provided adjacent to each other and
a sending portion of the positional information to the electric device.

3. An input device for inputting a signal into an electric device, comprising:
a sheet on which a wireless chip capable of reading function information by wireless communication recording the function information is arranged and
an operation device capable of wirelessly communicating with the wireless chip, which is movably disposed over the sheet.

4. An input device according to claim 1, wherein the wireless chip further comprises a resonant circuit, a power circuit connected to the resonant circuit, and a memory circuit connected to the power circuit.

5. An input device according to claim 1, wherein the wireless chip further comprises a resonant circuit, a power circuit connected to the resonant circuit, a memory circuit connected to the power circuit, and a control circuit connected to the power circuit and the memory circuit.

6. An input device according to claim 1, wherein the wireless chip further comprises a resonant circuit, a power circuit connected to the resonant circuit, and a memory circuit connected to the power circuit and
the pointing device includes:
an analyzing portion of positional information for obtaining information of a position on the sheet by reading information in the wireless chip provided adjacent to each other and
a sending portion of the positional information to the electric device.

7. An input device according to claim 1, wherein the wireless chip further comprises a resonant circuit, a power circuit connected to the resonant circuit, a memory circuit connected to the power circuit, and a control circuit connected to the power circuit and the memory circuit and
the pointing device includes:
an analyzing portion of positional information for obtaining information of a position on the sheet by reading information in the wireless chip provided adjacent to each other and
a sending portion of the positional information to the electric device.

8. An input device according to claim 1, wherein the pointing device is operated with an operator's foot.

9. An input device according to claim 2, wherein the pointing device is operated with an operator's foot.

10. An input device according to claim 3, wherein the operation device is operated with an operator's foot.

11. An input device according to claim 4, wherein the memory circuit includes a memory comprising a structure in which data cannot be rewritten.

12. An input device according to claim 5, wherein the memory circuit includes a memory comprising a structure in which data cannot be rewritten.

13. An input device according to claim 6, wherein the memory circuit includes a memory comprising a structure in which data cannot be rewritten.

14. An input device according to claim 7, wherein the memory circuit includes a memory comprising a structure in which data cannot be rewritten.

15. An input device according to claim 4, wherein the memory circuit includes a memory comprising a structure in which data can be rewritten.

16. An input device according to claim 5, wherein the memory circuit includes a memory comprising a structure in which data can be rewritten.

17. An input device according to claim 6, wherein the memory circuit includes a memory comprising a structure in which data can be rewritten.

18. An input device according to claim 7, wherein the memory circuit includes a memory comprising a structure in which data can be rewritten.

19. An input device according to claim 4, wherein the memory circuit includes a write once memory.

20. An input device according to claim 5, wherein the memory circuit includes a write once memory.

21. An input device according to claim 6, wherein the memory circuit includes a write once memory.

22. An input device according to claim 7, wherein the memory circuit includes a write once memory.

23. An input device according to claim 1, wherein the electric device is a computer.

24. An input device according to claim 2, wherein the electric device is a computer.

25. An input device according to claim 3, wherein the electric device is a computer.

26. An input system comprising:
an electric device displaying a cursor and
an input device which inputs a signal into the electric device,
wherein the input device includes:
a sheet on which a wireless chip capable of reading positional information by wireless communication recording the positional information is arranged and
a pointing device capable of wirelessly communicating with the wireless chip, which is movably disposed over the sheet

27. An input system comprising:
an electric device displaying a cursor and
an input device which inputs a signal into the electric device,
wherein the input device includes:
a sheet on which a plurality of wireless chips capable of reading positional information by wireless communication recording the positional information are arranged and
a pointing device capable of wirelessly communicating with the wireless chips, which is movably disposed over the sheet, and
the pointing device includes:
an analyzing portion of positional information for obtaining information of a position on the sheet by reading information in the plurality of wireless chips provided adjacent to each other and
a sending portion of the positional information to the electric device.

28. An input system comprising:
an electric device displaying a cursor and
an input device which inputs a signal into the electric device,
wherein the input device includes:
a sheet on which a wireless chip capable of reading function information by wireless communication recording the function information is arranged and
a operation device capable of wirelessly communicating with the wireless chip, which is movably disposed over the sheet.

29. An input system according to claim 26, wherein the wireless chip comprises a resonant circuit, a power circuit connected to the resonant circuit, and a memory circuit connected to the power circuit.

30. An input system according to claim 26, wherein the wireless chip comprises a resonant circuit, a power circuit connected to the resonant circuit, and a memory circuit connected to the power circuit.

31. An input system according to claim 26, wherein the wireless chip comprises a resonant circuit, a power circuit connected to the resonant circuit, and a memory circuit connected to the power circuit,
the pointing device includes:
an analyzing portion of positional information for obtaining information of a position on the sheet by reading information in the plurality of wireless chip provided adjacent to each other and
a sending portion of the positional information to the electric device.

32. An input system according to claim 26, wherein the wireless chip comprises a resonant circuit, a power circuit connected to the resonant circuit, a memory circuit connected to the power circuit, and a control circuit connected to the power circuit and the memory circuit, and
the pointing device includes:
an analyzing portion of positional information for obtaining information of a position on the sheet by reading information in the wireless chip provided adjacent to each other and
a sending portion of the positional information to the electric device.

33. An input system according to claim 26, wherein the pointing device is operated with an operator's foot.

34. An input system according to claim 27, wherein the pointing device is operated with an operator's foot.

35. An input system according to claim 28, wherein the operation device is operated with an operator's foot.

36. An input system according to claim 29, wherein the memory circuit includes a memory comprising a structure in which data cannot be rewritten.

37. An input system according to claim 30, wherein the memory circuit includes a memory comprising a structure in which data cannot be rewritten.

38. An input system according to claim 31, wherein the memory circuit includes a memory comprising a structure in which data cannot be rewritten.

39. An input system according to claim 32, wherein the memory circuit includes a memory comprising a structure in which data cannot be rewritten.

40. An input system according to claim 29, wherein the memory circuit includes a memory comprising a structure in which data can be rewritten.

41. An input system according to claim 30, wherein the memory circuit includes a memory comprising a structure in which data can be rewritten.

42. An input system according to claim 31, wherein the memory circuit includes a memory comprising a structure in which data can be rewritten.

43. An input system according to claim 32, wherein the memory circuit includes a memory comprising a structure in which data can be rewritten.

44. An input system according to claim 29, wherein the memory circuit comprises a write once memory.

45. An input system according to claim 30, wherein the memory circuit comprises a write once memory.

46. An input system according to claim 31, wherein the memory circuit comprises a write once memory.

47. An input system according to claim 32, wherein the memory circuit comprises a write once memory.

48. An input system according to claim 26, wherein the electric device is a computer.

49. An input system according to claim 27, wherein the electric device is a computer.

50. An input system according to claim 28, wherein the electric device is a computer.
